(19) United States
(12) Patent Application Publication
(10) Pub. No.: US 2026/0110987 A1
(43) Pub. Date: Apr. 23, 2026

(54) EXTERNAL PART COMPONENT OF A WATCH OR OF A FASHION OR JEWELLERY ITEM AND METHOD FOR MANUFACTURING SUCH AN EXTERNAL PART COMPONENT

(71) Applicant: Comadur SA, Le Locle (CH)

(72) Inventors: Jan LINTYMER, Mamirolle (FR); Benoit Giry, Villers-Ie-Iac (FR); Gabriel Rittiner, Le Locle (CH); Pierry Vuille, Les Emibois (CH)

(73) Assignee: Comadur SA, Le Locle (CH)

(21) Appl. No.: 19/427,380

(22) Filed: Dec. 19, 2025

Related U.S. Application Data
(62) Division of application No. 18/154,076, filed on Jan. 13, 2023.

(30) Foreign Application Priority Data
Feb. 7, 2022 (EP) 22155491.8
Aug. 22, 2022 (EP) 22191546.5

(51) Int. Cl. G04B 19/10; A44C 27/00; G04B 19/12; G04D 3/00

(52) U.S. Cl. CPC G04B 19/10; A44C 27/00; G04B 19/12; G04D 3/0092

(57) ABSTRACT

An external part component (10) of a watch, of a fashion item or of a jewellery item, including a substrate (11) made of a transparent material, the substrate (11) including an upper face (110) opposite to a lower face (111), the external part component (10) including a base layer (12) deposited over a first portion (1101) of the upper face (110) and at least one secondary layer (13) deposited over the base layer (12) and over a second portion (1102) of the upper face (110), the first and second portions (1101, 1102) of the upper face (110) having different surface conditions.

### CROSS REFERENCE TO RELATED APPLICATION

This application is a divisional of U.S. application Ser. No. 18/154,076, filed Jan. 13, 2023, which claims priorities to European Patent Application Nos. 22155491.8 filed Feb. 7, 2022 and 22191546.5 filed Aug. 22, 2022, the entire contents of which are incorporated herein by reference.

### TECHNICAL FIELD OF THE INVENTION

The invention relates to the watchmaking, fashion or jewellery item field, and more particularly relates to an external part component of a watch, of a fashion or jewellery item and a method for manufacturing such an external part component.

In the present text, the concept of “fashion item” includes clothing items or accessories, such as belts, shoes, garments, etc., and further includes eyewear items, phone items, or any decorative object.

### TECHNOLOGICAL BACKGROUND

In the watchmaking field in particular, external part components for watches, flanges, bezels, etc. may have decorations made from thin layers deposited at the surface of a substrate.

Depending on the dimension and the number of details of the decoration of the external part component, the latter may be relatively complex to make. In particular, compliance with the alignment tolerances of the thin layers with respect to one another may be particularly problematic.

In this context, the present invention aims to improve the accuracy and the quality of the decorations of an external part component of a watch, in particular in the visual aspect of juxtaposed thin layers visible through a transparent substrate.

In particular, the invention solves the problem of compliance with the alignment tolerances of the decorations on an external part component, in particular of the alignment of the thin layer with respect to one another and with respect to structurations over which said thin layers are deposited.

In general, the aforementioned problems are encountered in the fashion or jewellery item fields.

### SUMMARY OF THE INVENTION

To this end, the invention relates to an external part component of a watch, of a fashion item or of a jewellery item, comprising a substrate made of a transparent material, said substrate comprising an upper face opposite to a polished lower face. The external part component further comprises a base layer deposited over a first portion of the upper face and at least one secondary layer deposited over a second portion of the upper face. The first and second portions of the upper face have different surface conditions.

In particular embodiments, the invention may further include one or more of the following features, considered separately or according to any technically feasible combinations.

In particular embodiments, the first portion of the upper face is polished, and the second portion of the upper face has at least one structuration.

In particular embodiments, the base layer and the secondary layer have different compositions.

In particular embodiments, the base layer and the secondary layer include a through opening leading onto a third portion of the upper face of the substrate.

In particular embodiments, the external part component includes a lower base layer deposited over a first portion of the lower face, said external part component also comprising a lower secondary layer deposited over a structured second portion of the lower face. The lower base and lower secondary layers include a lower through opening leading onto a third portion of the lower face extending at least opposite the first and second portions of the upper face.

According to another aspect, the present invention relates to a watch dial formed by an external part component as described before.

According to still another aspect, the present invention relates to a decorative element of a phone case formed by an external part component as described before.

According to still another aspect, the present invention relates to a method for manufacturing an external part component of a watch, of a fashion or jewellery item comprising the following steps:
polishing of a lower face of a substrate made of a transparent material,
deposition of a base layer over all or part of the surface of an upper face of the substrate,
localised removal of the base layer, in which a portion of said base layer is preserved over a first portion of the upper face of the substrate, said removal being carried out so as to form at least one pocket leading onto a second portion of the upper face of the substrate and so as to structure said second portion of the upper face of the substrate,
deposition of a secondary layer over the base layer and over the second portion of the upper face of the substrate.

In particular implementations, the method includes a preliminary step of polishing the upper face of the substrate.

In particular implementations, the method includes an etching step in which a portion of the base layer and a portion of the secondary layer are eliminated over the entirety of their thickness, without the substrate being impacted, so as to form at least one through opening leading onto a third portion of the upper face of the substrate.

In particular implementations, the method includes successive steps of:
deposition of a lower base layer over all or part of the surface of the lower face,
localised removal of the lower base layer so as to carry out a lower structuration over a second portion of the lower face of the substrate,
deposition of a lower secondary layer over the lower base layer and over the lower structuration,
etching so as to generate one or more lower through opening(s) leading onto a third portion of the lower face of the substrate, said lower through openings being generated so that said third portion of the lower face extends at least opposite the first and second portions of the upper face.

In particular implementations, the method includes a final step of depositing an anti-reflection coating over either one or both of the upper and lower faces of the substrate.

In some particular implementations, the step of local removal of the base layer is carried by a laser beam.

### BRIEF DESCRIPTION OF THE FIGURES

Other features and advantages of the invention will appear upon reading the following detailed description given as a non-limiting example, with reference to the appended drawings wherein:

FIGS. 1 and 2, respectively, schematically represent a sectional view of an external part component during making thereof by implementation of steps of a manufacturing method according to a preferred embodiment of the invention;

FIGS. 3 to 5, respectively, schematically represent a sectional view of an external part component obtained by the implementation of the manufacturing method according to the invention, in some embodiments of the invention.

It should be noted that the figures are not to scale.

### DETAILED DESCRIPTION OF THE INVENTION

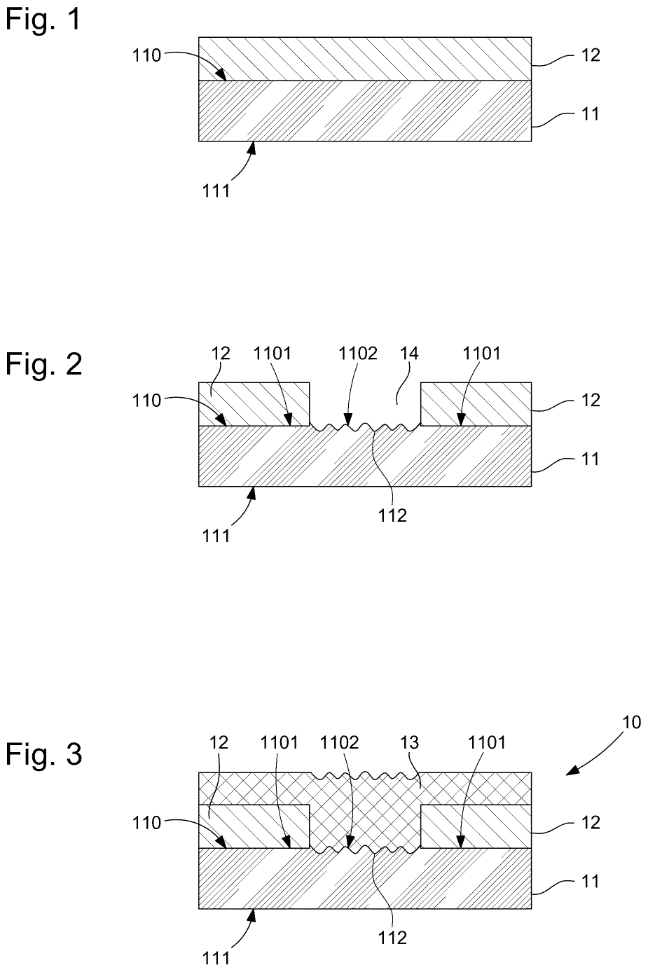

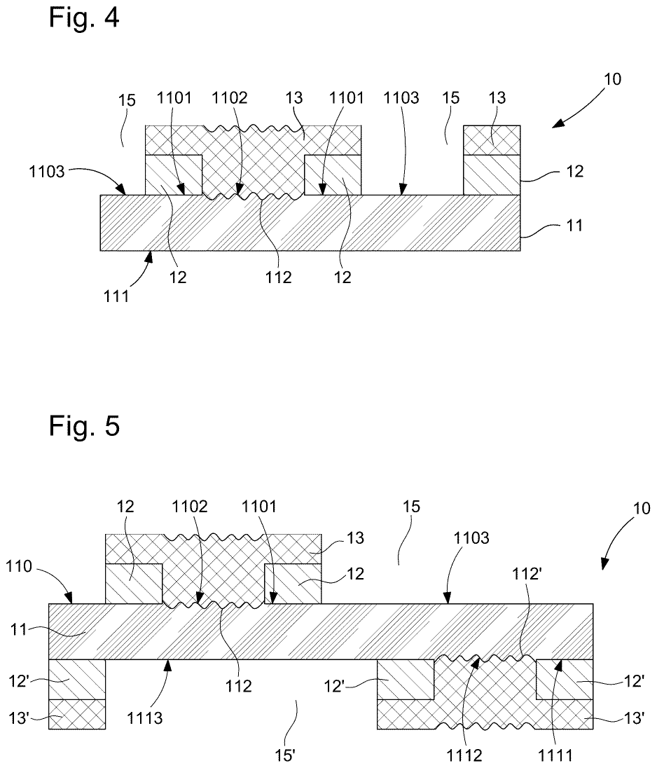

The present invention relates to an external part component 10 as represented in FIGS. 3 to 5 in different embodiments, and as represented, during steps of manufacture thereof, in FIGS. 1 and 2.

Advantageously, the invention may consist of a decorative element of a watch, of a fashion item, or of a jewellery item.

The terms “fashion items” define any clothing item or accessory, such as a belt, a shoe, a garment, etc., and further include eyewear items, phone items, such as phone cases, or any decorative object.

The external part component 10 comprises a substrate 11 made of a transparent material. It should be noted that the term “transparent” refers in the present text to a capability of a material to let all or part of a light radiation pass, in particular light visible to the naked eye. Such a transparent material may be sapphire, glass, etc.

The substrate 11 includes an upper face 110 opposite to a lower face 111 from which a user is intended to see a decoration of the external part component 10, through said substrate 11, at least in the embodiments of the invention represented in FIGS. 3 and 4. Advantageously, the lower face 111 of the substrate 11 is therefore preferably polished.

In particular, in these embodiments, the lower face 111 is intended to be oriented towards an external environment and the upper face 110 is intended to be oriented towards an internal environment, for example opposite a horological movement, in the case where the external part component 10 is a component of a watch.

In the present text, the relative terms “lower” and “upper” are used herein to describe elements with regards to their arrangement represented in the figures and do not necessarily describe an absolute position of said elements. Consequently, a person skilled in the art understands that such terms may be interchangeable with other terms and that the embodiments described herein are capable of operating in orientations other than those illustrated in the figures and described.

The external part component 10 comprises a base layer 12 deposited over a first portion 1101 of the upper face 110 and at least one secondary layer 13 deposited over the base layer 12 and over a second portion 1102 of the upper face 110 not covered by said base layer 12. As shown in FIGS. 3 to 5, the first and second portions 1101 and 1102 of the upper face 110 are contiguous to each other.

Advantageously, the first and second portions 1101 and 1102 of the upper face 110 have different surface conditions.

In particular, the first portion 1101 of the upper face 110 is preferably polished, and the second portion 1102 of the upper face 110 preferably has at least one structuration 112. In the present description of the invention, reference is made hereinbelow to one single second portion 1102 and therefore one single structuration 112 to facilitate reading. The concept of “structuration” herein defines a surface whose topography has been modified and this may consist of a satin-finishing, a texturing, an etching, etc. Advantageously, the combination between the base layer 12, the secondary layer 13 and the different surface conditions of the upper face 110 of the substrate 11 may form a particularly attractive decoration.

As shown in FIGS. 3 to 5, the secondary layer 13 matches with the structure shape 112 over a portion of its surface opposite the second portion 1102 of the upper face 110. Hence, the secondary layer 13 replicates the structuration 112 over its outer face, i.e. its face oriented in a direction opposite to the substrate.

Preferably, the base layer 12 and the secondary layer 13 have different compositions. They may be made of a metal, such as chromium, gold, titanium, zirconium, etc., or of a ceramic or any suitable material. Either one or both of these layers may be formed by a stack of thin layers, in a manner known per se to a person skilled in the art. The base layer 12 and/or the secondary layer 13 may be opaque or translucent.

In an embodiment represented in FIG. 4, the base layer 12 and the secondary layer 13 may include a through opening 15 leading onto a third portion 1103 of the upper face 110.

Advantageously, a user is therefore able to see through the external part component 10 when the base layer 12 and the secondary layer 13 include a through opening 15.

In this case, the external part component 10 may include an anti-reflection coating (not represented in the figures) deposited over the lower face 111 of the substrate 11 and/or over the secondary layer 13 and the third portion 1103 of the upper face 110 of the substrate 11.

In the embodiment represented in FIG. 5, the external part component 10 includes, over a first portion 1111 of the lower face 111 of the substrate 11, in a manner similar to the upper face 110, a base layer, called “lower base layer” 12′. Furthermore, a “secondary layer called lower secondary layer 13′” is deposited over a structured second portion 1112 of the lower face 111, called “lower structuration” 112′, and over the lower base layer 12′. In a manner similar to the base 12 and secondary 13 layers, the lower base layer 12′ and the lower secondary layer 13′ may be made of metallic or ceramic materials, or of any other suitable material, and preferably have different compositions. Either one or both of these layers may be formed by a stack of thin layers, in a manner known per se to a person skilled in the art.

Similarly to the embodiment represented in FIG. 4, the lower base layer 12′ and the lower secondary layer 13′ may include at least one lower through opening 15′. Said lower through opening 15′ leads onto a third portion 1113 of the lower face 111 extending at least opposite the first and second portions 1101 and 1102 of the upper face 110, as shown in FIG. 5. That being so such that the decoration generated by the combination between the base layer 12, the secondary layer 13 and the different surface conditions of the upper face 110 of the substrate 11 is visible to a user looking through the substrate 11, from the lower face 111.

Also similarly to the embodiments represented in FIGS. 3 and 4, the lower secondary layer 13′ matches with the lower structuration 112′ over a portion of its surface opposite the second lower portion 1102 of the lower face 111. Hence, the lower secondary layer 13′ replicates the lower structuration 112′ over its outer face, i.e. its face oriented in a direction opposite to the substrate 11, as shown in FIG. 5.

Moreover, the external part component 10 is preferably made by a manufacturing method whose steps are chronologically represented by FIGS. 1 to 3 and possibly 1 to 4 or 1 to 5 in other examples of implementation.

More particularly, the manufacturing method comprises a step of polishing the lower face 111 of the substrate 11, followed by a step of depositing the base layer 12 over all or part of the surface of the upper face 110 of the substrate 11, as represented in FIG. 1.

Such a deposition may be carried by a physical vapour deposition method, a chemical vapour deposition method, or by any other suitable method.

Preferably, the upper face 110 is polished during a preliminary polishing step, prior to the deposition of the base layer 12.

Next, the method includes a step of localised removal of the base layer 12, as represented in FIG. 2, so as to form one or more pocket(s) 14 leading onto the upper face 110 of the substrate 11 and, at the same time, structure said upper face 110 at the or each of the pockets 14 in order to carry out a structuration 112.

More particularly, upon completion of the localised removal step, the portion of the base layer 12 that is not affected by the removal rests against the first portion 1101 of the upper face 110 of the substrate 11, the pockets 14 lead onto the second portion 1102 of the upper face 110, and said second portion 1102 of the upper face 110 is structured. Thus, the or each structuration 112 perfectly coincides with the pocket 14 with which it is generated, and thus with the base layer 12.

The local removal of the base layer 12, and consequently, the structuration(s) 112 of the second portion 1102 of the upper face 110, is preferably carried out by laser machining. Alternatively, the local removal step may be carried out by robotised etching with a diamond bit, by mechanical, chemical machining, etc.

Next, a step of depositing a secondary layer 13 is carried out over the base layer 12 and in the pockets 14, i.e. over the second portion 1102 of the upper face 110 of the substrate 11, so as to obtain an external part component 10, as shown in FIG. 3. Hence, compliance with the alignment tolerances of the base layer 12 and of the secondary layer 13 with the first and second portions 1101 and 1102 of the upper face 110 having different surface conditions is ensured.

It should be noted that, thanks to the features of the invention, the visual aspect of the decoration of the external part component 10 may be particularly attractive to the extent that in addition to the contrast between the possible difference in colours of the base layer 12 and of the secondary layer 13, there is the contrast between the different surface conditions of the different portions of the upper face 110 over which said layers are respectively deposited.

The deposition of the secondary layer 13 may also be carried by a physical vapour deposition method, a chemical vapour deposition method, or by any other suitable method.

Finally, the method may include an etching step in which a portion of the base layer 12 and a portion of the secondary layer 13 are eliminated over the entirety of their thickness, so as to shape said layers according to a predefined shape, without the substrate 11 being affected, as represented in FIG. 4.

This etching step allows forming at least one through opening 15 leading onto the third portion 1103 of the upper face 110 of the substrate 11.

Such an etching step may be implemented by photolithography, laser machining, etc.

Alternatively to this final step, in order to make an external part component according to the embodiment represented in FIG. 5, the method may include successive steps of depositing lower base layer 12′ over all or part of the surface of the lower face 111, then of localised removal of the lower base layer 12′ in a similar manner as the step of localised removal of the based layer 12. More particularly, during the step of localised removal of the lower base layer 12′, a lower structuration 112′ is carried out over a second portion 1112 of the lower face 111 of the substrate 11, the remaining lower base layer 12′ resting against a first portion 1111 of said lower face 111. Next, a step of depositing a lower secondary layer 13′ is carried out over the lower base layer 12′ and over the lower structuration 112′.

Afterwards, an etching step intended to generate one or more lower through opening(s) 15′ leading onto a third portion 1111 of the lower face 111 of the substrate 11, as shown in FIG. 5. Advantageously, this or these lower through opening(s) 15′ are generated so that said third portion 1111 of the lower face 111 extends at least opposite the first and second portions 1101 and 1102 of the upper face 110.

This embodiment represented in FIG. 5 is particularly advantageous for applications in which the external part component 10 may be visible in all directions for example if it is integrated to a tourbillon or in a skeleton watch.

A possible final step of anti-reflection coating deposition may be carried out following these steps, over either one or both of the upper 110 and lower 111 faces of the substrate 11.

More generally, it should be noted that the implementations and embodiments considered above have been described by way of non-limiting examples, and that other variants are consequently possible.

In particular, the manufacturing method may include a third layer that may be deposited over the secondary layer 13 and in said pocket(s), in a similar manner as the step of depositing the secondary layer 13.

In general, it may be contemplated that the method includes several localised removal steps, each followed by a step of depositing an additional layer, depending on the desired decoration.

It should be noted that the lower face 111 may be intended to be oriented towards an internal environment and the upper face 110 may be intended to be oriented towards an external environment, i.e. towards a user.

Preferably yet without limitation, the external part component 10 according to the invention forms a dial, a crystal, a bezel or a flange of a watch.

In another advantageous variant, the external part component 10 forms a decorative element of a phone case. The decorative element may extend over all or part of the visible surface of the phone case.

1. A method for manufacturing an external part component of a watch, a fashion or jewellery item, comprising the following steps:
polishing of a lower face of a substrate made of a transparent material;
deposition of a base layer over all or part of the surface of an upper face of the substrate;
localised removal of the base layer, in which a portion of said base layer is preserved over a first portion of the upper face of the substrate, said removal being carried out so as to form at least one pocket leading onto a second portion of the upper face of the substrate and so as to structure said second portion of the upper face of the substrate; and
deposition of a secondary layer over the base layer and over the second portion of the upper face of the substrate.

2. The manufacturing method according to claim 1, further comprising a preliminary step of polishing the upper face of the substrate.

3. The manufacturing method according to claim 1, further comprising an etching step in which a portion of the base layer and a portion of the secondary layer are eliminated without the substrate being impacted, so as to form at least one through opening leading onto a third portion of the upper face of the substrate.

4. The manufacturing method according to claim 1, further comprising successive steps of:
deposition of a lower base layer over all or part of the surface of the lower face;
localised removal of the lower base layer so as to carry out a lower structuration over a second portion of the lower face of the substrate, the remaining lower base layer resting against a first portion of said lower face;
deposition of a lower secondary layer over the lower base layer and over the lower structuration; and
etching so as to generate one or more lower through opening(s) leading onto a third portion of the lower face of the substrate, said lower through openings being generated so that said third portion of the lower face extends at least opposite the first and second portions of the upper face.

5. The manufacturing method according to claim 1, further comprising a final step of depositing an anti-reflection coating over either one or both of the upper and lower faces of the substrate.
